(19) United States
(12) Patent Application Publication
(10) Pub. No.: US 2021/0141295 A1
(43) Pub. Date: May 13, 2021

(54) HANDHELD GIMBAL

(71) Applicant: SZ DJI TECHNOLOGY CO., LTD., Shenzhen (CN)

(72) Inventors: Hongpeng CHU, Shenzhen (CN); Hao LIU, Shenzhen (CN)

(21) Appl. No.: 17/122,969

(22) Filed: Dec. 15, 2020

Related U.S. Application Data
(63) Continuation of application No. PCT/CN2018/112663, filed on Oct. 30, 2018.

(30) Foreign Application Priority Data
Jul. 18, 2018 (CN) 201821150038.7

(51) Int. Cl. G03B 17/56; F16M 13/04; F16M 11/04; F16B 2/02

(52) U.S. Cl. CPC G03B 17/561; F16M 13/04; F16M 11/10; F16B 2/02; F16M 11/041

(57) ABSTRACT

A handheld gimbal includes a handheld member, a gimbal body, a fixing base, a movable member, and a lock member. An end of the gimbal body is connected to the handheld member. The fixing base includes a base body and a fixed member arranged at the base body. The base body is mounted at another end of the gimbal body. The movable member is movably connected to the fixed member. The lock member is arranged on at least one of the fixed member or the movable member and configured to cause the movable member and the fixed member to close or separate. The fixed member and the movable member are configured to fix a photographing device when being closed or allow the photographing device to be detached when being separated.

### CROSS-REFERENCE TO RELATED APPLICATIONS

This application is a continuation of International Application No. PCT/CN2018/112663, filed Oct. 30, 2018, which claims priority to Chinese Application No. 201821150038.7, filed Jul. 18, 2018, the entire contents of both of which are incorporated herein by reference.

### TECHNICAL FIELD

The present disclosure relates to a handheld gimbal.

### BACKGROUND

With an increasing requirement for imaging quality, an image vibration problem caused by directly holding a camera with hands to photograph is no longer acceptable by consumers. A handheld gimbal can greatly resolve the image vibration problem. Before using the handheld gimbal to photograph, the camera needs to be fixedly connected to the handheld gimbal. The fixed connection is usually a detachable connection.

The existing fixed connection includes a threaded connection or a full coverage connection of the camera. The threaded connection is not convenient to mount and detach. A volume of a connection mechanism of the full coverage connection is too large, which blocks the camera heavily. Moreover, when the camera needs to be operated by touching a screen, the full coverage connection will affect the user experience of using the camera by the handheld gimbal.

### SUMMARY

Embodiments of the present disclosure provide a handheld gimbal including a handheld member, a gimbal body, a fixing base, a movable member, and a lock member. An end of the gimbal body is connected to the handheld member. The fixing base includes a base body and a fixed member arranged at the base body. The base body is mounted at another end of the gimbal body. The movable member is movably connected to the fixed member. The lock member is arranged on at least one of the fixed member or the movable member and configured to cause the movable member and the fixed member to close or separate. The fixed member and the movable member are configured to fix a photographing device when being closed or allow the photographing device to be detached when being separated.

### BRIEF DESCRIPTION OF THE DRAWINGS

FIG. 1 is a schematic structural diagram of a handheld gimbal according to some embodiments of the present disclosure.

FIG. 2 is a schematic exploded diagram showing a movable member and a lock member of the handheld gimbal in FIG. 1.

FIG. 3A, 3B, and 3C are schematic status diagrams from three angles showing a status with a camera fixed at the handheld gimbal according to some embodiments of the present disclosure.

FIG. 4A, 4B, and 4C are schematic status diagrams from three angles showing a process of detaching the camera from the handheld gimbal according to some embodiments of the present disclosure.

### REFERENCE NUMERALS

1—Gimbal body; 11—Support member; 12—Connection rod; 121—Horizontal rod; 122—First vertical rod; 123—Second vertical rod;
2—Fixing base; 21—Base body; 22—Fixed member; 211—Front surface; 212—Side surface; 213—Top surface; 214—Bottom surface; 23—Electrical connection member;
3—Movable member; 31—Snap hook;
4—Lock member; 41—Linkage; 42—Lock buckle; 421—Reverse hook;
5—Camera; 51—Lens;
6—Handheld member; 61—Operation member

### DETAILED DESCRIPTION OF THE EMBODIMENTS

Embodiments of the present disclosure provide a handheld gimbal, which is configured to carry a photographing device. The handheld gimbal may include a handheld member, a gimbal body, a fixing base, a movable member, and a lock member. An end of the gimbal body may be connected to the handheld member. The fixing base may include a base body and a fixed member arranged at the base body. The base body may be mounted at the other end of the gimbal body. The movable member may be movably connected to the fixed member. The lock member may be arranged on at least one of the fixed member or the movable member and may be configured to cause the movable member and the fixed member to close or separate. When closing, the fixed member and the movable member may fix the photographing device. After the fixed member and the movable member are separated, the photographing device may be detached. The handheld gimbal consistent with embodiments of the present disclosure may carry any type of the photographing device, including but not limited to a camera, a recorder, a mobile device, etc.

To make purposes, technical solutions, and advantages of embodiments of the present disclosure clearer, embodiments of the present disclosure are further described in detail in connection with specific embodiments and accompanying drawings.

Embodiments of the present disclosure provide a handheld gimbal, which may be configured to carry a photographing device to ensure the imaging quality of the photographing device. Embodiments of the present disclosure may be described by using a camera as an example. As shown in FIG. 1, the handheld gimbal includes a handheld member 6. The handheld member 6 may be a handle, which may be configured for the user to hold. An operation member 61 is arranged at the handheld member 6. The user may operate the handheld gimbal via the operation member 61 and operate the photographing device carried by the handheld gimbal.

The gimbal body 1 may be a three-axis gimbal, which includes a support member 11 and a connection rod 12. An end of the support member 11 may be mounted at an end of the handheld member 6 and may drive the gimbal body 1 to rotate about a yaw axis relative to the handheld member 6. A center portion of the connection rod 12 may be mounted to the other end of the support member 11. In some embodiments, the connection rod 12 is a “Z” shape rod formed by a horizontal rod 121, a first vertical rod 122, and a second vertical rod 123. As shown in a view angle of FIG. 1, an end of the horizontal rod 121 may be rotatably connected to a top end of the support member 11, such that the connection rod 12 may rotate about a roll axis relative to the support member 11. In some other embodiments, the connection rod 12 may include a curved rod or have another shape.

The fixing base 2 includes a base body 21 and a fixed member 22 arranged at the base body 21. The base body 21 is mounted at an end of the gimbal body 1 and forms an accommodation space, which may be configured to accommodate the camera 5. As shown in FIG. 1, the base body 21 is rotatably connected to the top end of the first vertical rod 122. The base may rotate about a pitch axis relative to the gimbal body 1. The fixed member 22 may be formed integrally at the base body 21, or may be a part separated from the base body 21 and mounted at the base body 21.

The movable member 3 is movably connected to the fixed member 22. In some embodiments, as shown in FIG. 1, the fixed member 22 and the movable member 3 are both curved parts, which are rotatably connected to each other. As shown in FIG. 1, a snap hook 31 is formed at the top end of the movable member 3. The bottom end of the movable member 3 is rotatably connected to the bottom end of the fixed member 22. Thus, the movable member 33 may be moved close to or separated from the fixed member 22.

The lock member 4 is arranged at the fixed member 22 and may be configured to cause the movable member 3 to be moved close to or separated from the fixed member 22. Refer to FIG. 2, the lock member 4 includes a linkage 41 and a lock buckle 42, a first end of the linkage 41 may be rotatably connected to the top end of the fixed member 22. A reverse hook 421 is formed at a first end of the lock buckle 42. A second end of the lock buckle 42 is rotatably connected to a second end of the linkage 41.

As shown in FIG. 2, the support member 11 includes two supporting rods. The second vertical rod 123 of the connection rod 12 is partially located in the two supporting rods. A top end of the support member 11 is rotatably connected to a connection position of the horizontal rod 121 and the second vertical rod 123. Therefore, the connection rod 12 may rotate about the roll axis relative to the support member 11. A lower portion of the second vertical rod 123 may include a weight portion, thus, an additional weight block may not need to be added to the handheld gimbal, and the volume of the handheld gimbal may be reduced. In some other embodiments, the support member 11 may only include one supporting rod, meanwhile, the second vertical rod 123 may include two vertical rods. The support member 11 may be located in the two vertical rods of the second vertical rod 123. As such, the connection rod 12 may also rotate about the roll axis.

The three axes of the handheld gimbal consistent with embodiments of the present disclosure have a sequence from the handheld member 6 to the fixing base 2 of the yaw axis, the roll axis, and the pitch axis. The sequence of the three axes of the handheld gimbal may be another sequence. Moreover, the handheld gimbal may also be a two-axis gimbal, which is not limited by embodiments of the present disclosure.

As the handheld gimbal consistent with embodiments of the present disclosure, the camera 5 may be carried at the handheld gimbal by fixing a lens 51 of the camera by the fixed member 22 and the movable member 3. In some embodiments, the lens 51 of the camera may be first attached to the inner side of the fixed member 22. Then, the reverse hook 421 of the lock buckle may be clipped at the snap hook 31 of the movable member, and the lock buckle 42 may be pressed at the fixed member 22. During this process, the lock buckle 42 may drive the movable member 3 to move close to the fixed member 22 to cause the inner side of the movable member 3 to be attached to the lens 51. Since both the fixed member 22 and the movable member 3 are the curved parts, that is, both the fixed member 22 and the movable member 3 may partially match the shape of the lens 51. After the movable member 3 and the fixed member 22 are closed, the lens 51 may be tightly clamped to fix the camera 5. FIGS. 3A, 3B, and 3C show the status of the camera 5 being fixed at the handheld gimbal. When the camera 5 needs to be detached, the lock buckle 42 may be pulled up to release the reverse hook 421 of the lock buckle 42 and the snap hook 31 of the movable member, and the movable member 3 may be separated from the fixed member 22 to release the lens 51 of the camera to detach the camera 5. FIGS. 4A, 4B, and 4C show a process of the camera 5 being detached from the handheld gimbal.

Therefore, as the handheld gimbal consistent with embodiments of the present disclosure, via the cooperation of the fixed member 22, the movable member 3, and the lock member 4, only a simple operation may need to be performed on the lock member 4 and the movable member 3 to conveniently and quickly mount and detach the camera. The operation of the handheld gimbal may be simpler and quicker.

The above description is only exemplary, and embodiments of the present disclosure are not limited to this. In some other embodiments, the movable member 3 and the fixed member 22 may fix the camera 5 by tightly clamp other components of the camera 5. In this case, the movable member 3 and the fixed member 22 should match the shapes of the other components of the camera 5. In addition, the lock member 4 may be not arranged at the fixed member 22 but arranged at the movable member 3. That is, the first end of the linkage 41 may be rotatably connected to the top end of the movable member 3, the reverse hook 421 may be formed at the first end of the lock buckle 42, the second end of the lock buckle 42 may be rotatably connected to the second end of the linkage 41, and the top end of the fixed member 22 may be formed with the snap hook 31. Similar to the scenario in which the lock member 4 is arranged at the lock member 22, the camera 5 may also be fixed and detached by arranging the lock member 4 at the movable member 3.

In some embodiments, the fixed member 22 and the movable member 3 may include a rigid material, for example, hard plastic, metal, etc. By selecting the hard plastic, the weight and cost of the handheld gimbal may be reduced. Further, a washer may be arranged at the inner side of the fixed member 22, and a washer may also be arranged at the inner side of the movable member 3. The washer may be made of an elastic material such as rubber. When the fixed member 22 and the movable member 3 clamp the lens 51 of the camera tightly, the lens 51 may directly contact the washer. The washer may increase friction between the lens 51 and the fixed member 22 and the movable member 3 to fix the lens 5 more firmly. In addition, the washer may further avoid wear of the lens 51 to protect the lens 51.

In some embodiments, the accommodation space formed by the base body 21 may be configured to accommodate the camera 5. Hence, the shape of the base body 21 should match the shape of the camera 5. The base body 21 usually includes a plurality of surfaces. The plurality of surfaces may enclose to form the accommodation space. The fixed member 22 may be arranged at one of the plurality of surfaces. As shown in FIG. 1 to FIG. 4, the base body 21 includes a front surface 211, a side surface 212, a top surface 213, and a bottom surface 214. These surfaces enclose to form the accommodation space. The fixed member 22 may be arranged at the front surface 211, the side surface 212 is mounted at the top end of the first vertical rod 122. The top surface 213 and the bottom surface 214 are perpendicular to the front surface 211 and the side surface 212.

In some embodiments, the base body 21 is located between the fixed member 22 and the top end of the first vertical rod 122, that is, the front surface 211 of the base body extends from the side surface 212 to the fixed member 22. The top surface 213 and bottom surface 214 of the base body extend from the side surface 212 to the top end and bottom end of the fixed member 22, respectively. The base body 21 of embodiments of the present disclosure has a small volume and a simple structure. When the camera 5 is fixed at the base body 21, the base body 21 may only cover a small portion of the camera 5, that is, only the lens 51 to the side of the camera close to the side surface 212 of the base is covered by the base body, and other portions of the camera are still exposed. Since the base body 21 only covers a small portion of the camera 5, the convenience of the application may be improved.

As shown in FIG. 1 to FIG. 4, a controller is arranged inside the handheld member 6, and an operation member 61 is arranged at the surface of the handheld member 6. The operation member 61 may be a button or a touch operation interface and may be electrically connected to the controller.

An electrical connection member 23 is arranged at the side surface 212 of the base body of the fixing base, and the camera 5 may be arranged with a corresponding interface. When the camera 5 is fixed at the base body 21, the electrical connection member 23 may be inserted into the interface of the camera 5. The camera 5 may be electrically connected to the controller of the handle 11 via the electrical connection member 23 and internal wiring of the gimbal body 1. The user may control the camera 5 via the operation member 61. The controller may respond to the action of the operation member 61 to transmit a control instruction to the camera 5 to control the camera 5 to finish photographing.

In some other embodiments, the camera 5 may be connected to the handheld gimbal without the electrical connection member 23 but via wireless communication, for example, WiFi, Bluetooth, near-field communication (NFC), etc., to communicate with the handheld gimbal. Both the camera 5 and the handheld gimbal 11 may include a wireless communication circuit. Thus, the user may control the camera via the operation member 61. The controller may respond to the action of the operation member 61 to transmit the control instruction to the camera 5 via the wireless communication to control the camera to finish photographing.

The electrical connection member 23 may not only be arranged at the side surface 212 of the base body but also be arranged at the top surface 213 or the bottom surface 214 of the base body. The electrical connection member 23 may usually include a male connector, and the form is not limited, for example, an electrical connector, an electrical contact, an electrical socket, etc., may be used.

In some other embodiments of the present disclosure, a handheld gimbal is provided. Same or similar features to above embodiments are not repeated, only features different from the features of above embodiments are described in detail.

In some embodiments, the structure of the movable member 3 may be the same as the structure of the movable member 3 of above embodiments, and the structure of the lock member 4 may be different from the structure of the lock member 4 of above embodiments. The lock member may include a sleeve ring. The sleeve ring may be rotatably connected to the top end of the fixed member 22. The sleeve ring may sleeve the snap hook 31 of the movable member 3 to cause the movable member 3 and the fixed member 22 to close and clamp the lens 51 of the camera tightly.

When the camera 5 is being mounted, the lens 51 of the camera may be attached to the inner side of the fixed member 22 first, thus, the movable member 3 may be closed to the fixed member 22 to cause the inner side of the movable member 3 to attach the lens 51. Then, the snap hook 31 of the movable member 3 may be sleeved by the sleeve ring to cause the movable member 3 and the fixed member 22 to clamp the lens 51 tightly to fix the camera 5 together.

Similar to above embodiments, as the handheld gimbal of embodiments of the present disclosure, via the cooperation of the fixed member 22, the movable member 3, and the sleeve ring, only a simple operation may need to be performed on the sleeve ring and the movable member 3 to conveniently and quickly mount and detach the camera 5. The operation of the handheld gimbal may be simpler and faster.

In some other embodiments, a handheld gimbal may be provided. Same or similar features to above embodiments are not repeated. Only different features from above embodiments are described in detail below.

In some embodiments, the movable member 3 may have the same structure as the movable member 3 of above embodiments, and the lock member 4 may have a different structure from the lock member 4 of above embodiments. The lock member 4 may include a buckle assembly, which may include a male buckle and a female buckle. One of the male buckle and the female buckle may be fixed at the top end of the movable member 3, and the other one of the male buckle and the female buckle may be fixed at the top end of the fixed member 22.

When the camera 5 is being mounted, the lens 51 of the camera may be attached to the inner side of the fixed member 22, thus, the movable member 3 may be closed to the fixed member 22 to cause the inner side of the movable member to attach the lens 51 as well. Then, the male buckle may be pressed into the female buckle to cause the movable member 3 and the fixed member 22 to clamp the lens 51 tightly to fix the camera 5 together.

Similar to above embodiments, as the handheld gimbal of embodiments of the present disclosure, via the cooperation of the fixed member 22, the movable member 3, and the buckle assembly, only a simple operation may need to be performed on the buckle assembly and the movable member 3 to conveniently and quickly mount and detach the camera 5. The operation of the handheld gimbal may be simpler and faster.

Embodiments of the present disclosure are described in detail in connection with accompanying drawings. According to the above description, those skilled in the art should know embodiments of the present disclosure clearly.

Specific embodiments described above further describe the purposes, the technical solutions, and the beneficial effects of embodiments of the present disclosure in detail. The above-described embodiments are only specific embodiments of the present disclosure and are not intended to limit the present disclosure. Any modification, equivalent replacement, improvement, etc. made within the spirit and principle of the present disclosure are within the scope of the present disclosure.

The ordinal numbers used in the description and claims, such as “first,” “second,” “third,” etc., are used to describe the corresponding elements, which does not mean that the elements have any ordinal numbers, and does not represent an order of a certain element and another element, or an order of a manufacturing method. These ordinal numbers are only used to clearly distinguish one element with a certain name from another element with the same name. Moreover, directional terms mentioned in embodiments, such as “upper”, “lower”, “front”, “rear”, “left”, “right”, etc., are only directions with reference to the drawings, which are not used to limit the scope of the present disclosure. Throughout the drawings, the same elements are represented by the same or similar reference characters.

What is claimed is:

1. A handheld gimbal comprising:
a handheld member;
a gimbal body, an end of the gimbal body being connected to the handheld member;
a fixing base including a base body and a fixed member arranged at the base body, the base body being mounted at another end of the gimbal body;
a movable member movably connected to the fixed member; and
a lock member arranged at at least one of the fixed member or the movable member and configured to cause the movable member and the fixed member to close or separate, the fixed member and the movable member being configured to fix a photographing device when being closed or allow the photographing device to be detached when being separated.

2. The handheld gimbal of claim 1, wherein:
the fixed member and the movable member partially match a shape of at least one component of the photographing device; and
the fixed member and the movable member are configured to clamp the at least one component of the photographing device tightly when being closed to fix the photographing device.

3. The handheld gimbal of claim 2, wherein the at least one component of the photographing device includes a lens.

4. The handheld gimbal of claim 3, wherein each of the fixed member and the movable member includes a curved part.

5. The handheld gimbal of claim 1, wherein the movable member is rotatably connected to the fixed member.

6. The handheld gimbal of claim 1, wherein:
an end of the movable member is rotatably connected to an end of the fixed member; and
the lock member is arranged at at least one of another end of the movable member or another end of the fixed member.

7. The handheld gimbal of claim 6, wherein:
the other end of the movable member includes a snap hook;
the lock member is arranged at the other end of the fixed member and includes:
a linkage, an end of the linkage being rotatably connected to the other end of the fixed member; and
a lock buckle, an end of the lock buckle being rotatably connected to another end of the linkage and another end of the lock buckle including a reverse hook;
the reverse hook of the lock buckle is configured to be clipped to the snap hook of the movable member; and
the lock buckle is configured to press the fixed member to cause the movable member and the fixed member to close to clamp at least one component of the photographing device tightly.

8. The handheld gimbal of claim 6, wherein:
the other end of the movable member includes a snap hook; and
the lock member is arranged at the other end of the fixed member and includes:
a sleeve ring rotatably connected to the other end of the fixed member and being configured to be clipped to the snap hook of the movable member to cause the movable member and the fixed member to close to clamp at least one component of the photographing device tightly.

9. The handheld of claim 6, wherein:
the lock member includes a buckle assembly including a male buckle and a female buckle, one of the male buckle and the female buckle being fixed at the other end of the movable member, another one of the male buckle and the female buckle being fixed at the other end of the fixed member, and the male buckle being configured to be snapped into the female buckle to cause the movable member and the fixed member to close to clamp at least one component of the photographing device tightly.

10. The handheld gimbal of claim 1, wherein the base body of the fixing base is located between the fixed member and the other end of the gimbal body.

11. The handheld gimbal of claim 10, wherein:
the fixing base includes a plurality of surfaces;
the fixed member is arranged at one of the plurality of surfaces; and
the plurality of surfaces enclose to form an accommodation space configured to accommodate the photographing device.

12. The handheld gimbal of claim 11, wherein the plurality of surfaces include:
a front surface arranged with the fixed member;
a side surface mounted at the other end of the gimbal body; and
a top surface and a bottom surface perpendicular to the front surface and the side surface, the front surface extending from the side surface to the fixed member, and the top surface and the bottom surface extending from the side surface to two ends of the fixed member, respectively.

13. The handheld gimbal of claim 12, wherein:
the handheld member includes:
a handle, a controller being arranged in the handle; and
a connection rod, an end of the connection rod being mounted to an end of the handle, and another end of the connection rod being mounted with the fixing base;
an electrical connection member is arranged on at least one of the side surface, the top surface, or the bottom surface of the base body of the fixing base, and is configured to be electrically connected to the photographing device; and
the photographing device is connected to the controller via the electrical connection member.

14. The handheld gimbal of claim 13, wherein the electrical connection member includes at least one of an electrical connector, an electrical contact, or an electrical socket.

15. The handheld gimbal of claim 1, wherein a washer is arranged at at least one of an inner side of the fixed member or an inner side of the movable member.
